(19) United States
(12) Patent Application Publication
(10) Pub. No.: US 2012/0118265 A1
(43) Pub. Date: May 17, 2012

(54) ENGINE ASSEMBLY INCLUDING INDEPENDENT THROTTLE CONTROL FOR DEACTIVATED CYLINDERS

(75) Inventor: EDWARD J. KEATING, ORTONVILLE, MI (US)

(73) Assignee: GM GLOBAL TECHNOLOGY OPERATIONS, INC., DETROIT, MI (US)

(21) Appl. No.: 12/947,864

(22) Filed: Nov. 17, 2010

(51) Int. Cl. F02D 9/02

(52) U.S. Cl. 123/336

(57) ABSTRACT

An engine assembly may include an engine structure, a first intake valve located in a first intake port, a first valve lift mechanism, a second intake valve located in a second intake port, a second valve lift mechanism, a first throttle valve, and a second throttle valve. The second intake valve may be displaced to an open position by the second valve lift mechanism during a first mode and the second intake valve may be maintained in a closed position by the second valve lift mechanism during a second mode. The first throttle valve may be in communication with an air source and the first intake port and control air flow from the air source to the first intake port. The second throttle valve may be in communication with the air source and the second intake port and control air flow from the air source to the second intake port.

### FIELD

The present disclosure relates to throttle control for variable displacement engines.

### BACKGROUND

This section provides background information related to the present disclosure which is not necessarily prior art.

Internal combustion engines may combust a mixture of air and fuel in cylinders and thereby produce drive torque. Deactivating valve lift mechanisms may be included to increase fuel efficiency by effectively shutting off cylinders during low power demand conditions. However, switching the valve lift mechanisms between activated and deactivated conditions may produce a transition that is noticeable to a driver.

### SUMMARY

An engine assembly may include an engine structure, a first intake valve, a first valve lift mechanism, a second intake valve, a second valve lift mechanism, a first throttle valve, and a second throttle valve. The engine structure may define a first cylinder bore, a second cylinder bore, a first intake port in communication with an air source and the first cylinder bore, and a second intake port in communication with the air source and the second cylinder bore. The first intake valve may be located in the first intake port and the first valve lift mechanism may be engaged with the first intake valve. The second intake valve may be located in the second intake port and the second valve lift mechanism may be engaged with the second intake valve and operable in a first mode and a second mode. The second intake valve may be displaced to an open position by the second valve lift mechanism during the first mode and the second intake valve may be maintained in a closed position by the second valve lift mechanism during the second mode. The first throttle valve may be in communication with the air source and the first intake port and may control air flow from the air source to the first intake port. The second throttle valve may be in communication with the air source and the second intake port and may control air flow from the air source to the second intake port.

A method may include controlling an intake air flow to a first intake port of an engine assembly via a first throttle valve. A first intake valve located in the first intake port may be opened with a first valve lift mechanism. A second valve lift mechanism may be operated in a first mode where the second valve lift mechanism opens a second intake valve in a second intake port of the engine assembly. A second throttle valve in communication with the second intake port may be opened during the first mode. The valve lift mechanism may be operated in a second mode where the second valve lift mechanism maintains the second intake valve in a closed position. The second throttle valve may be closed during the second mode.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a top view of an engine assembly according to the present disclosure;

FIG. 2 is an additional top view of the engine assembly of FIG. 1 with the intake manifold removed;

FIG. 3 is a section view of the engine assembly of FIG. 1;

FIG. 4 is an additional section view of the engine assembly of FIG. 1;

FIG. 5 is a section view of an alternate engine assembly according to the present disclosure;

FIG. 6 is a section view of a valve lift mechanism from the engine assembly of FIG. 5; and

FIG. 7 is a graphical illustration of engine operation according to the present disclosure.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

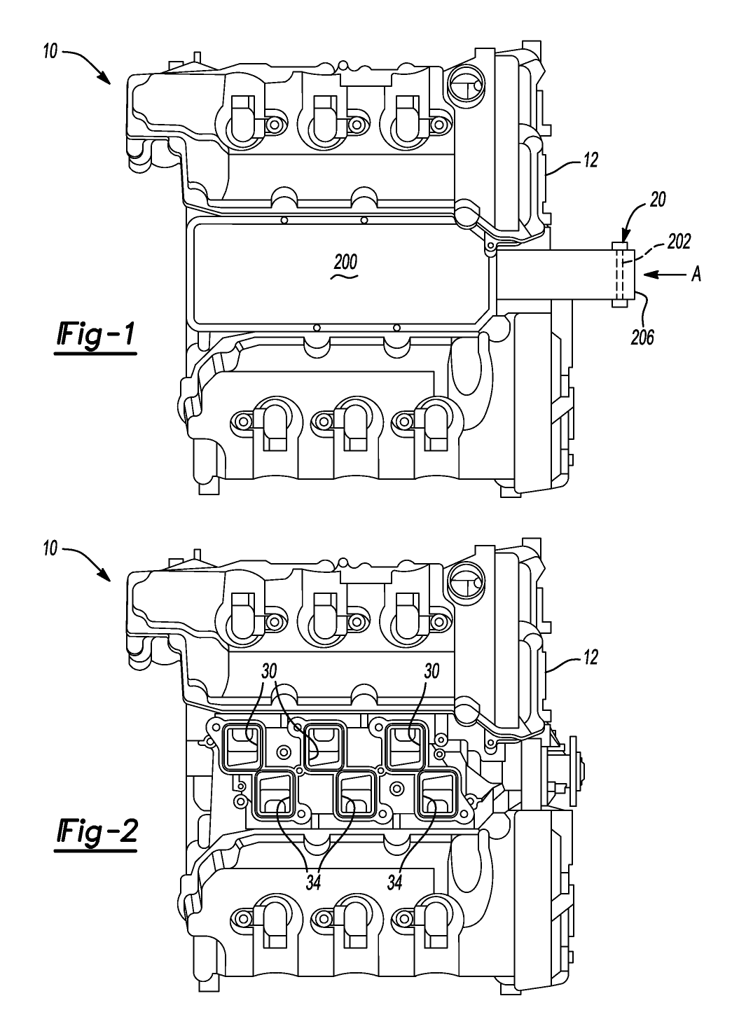

An engine assembly 10 is illustrated in FIGS. 1-4 and may include an engine structure 12, a crankshaft 14, pistons 16, a valvetrain assembly 18 and an intake assembly 20. The engine structure 12 may include an engine block 22 and cylinder heads 24. The engine structure 12 may define a first bank of cylinder bores 26 and a second bank of cylinder bores 28 disposed at an angle relative to one another. However, while described in combination with a V-engine configuration, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations.

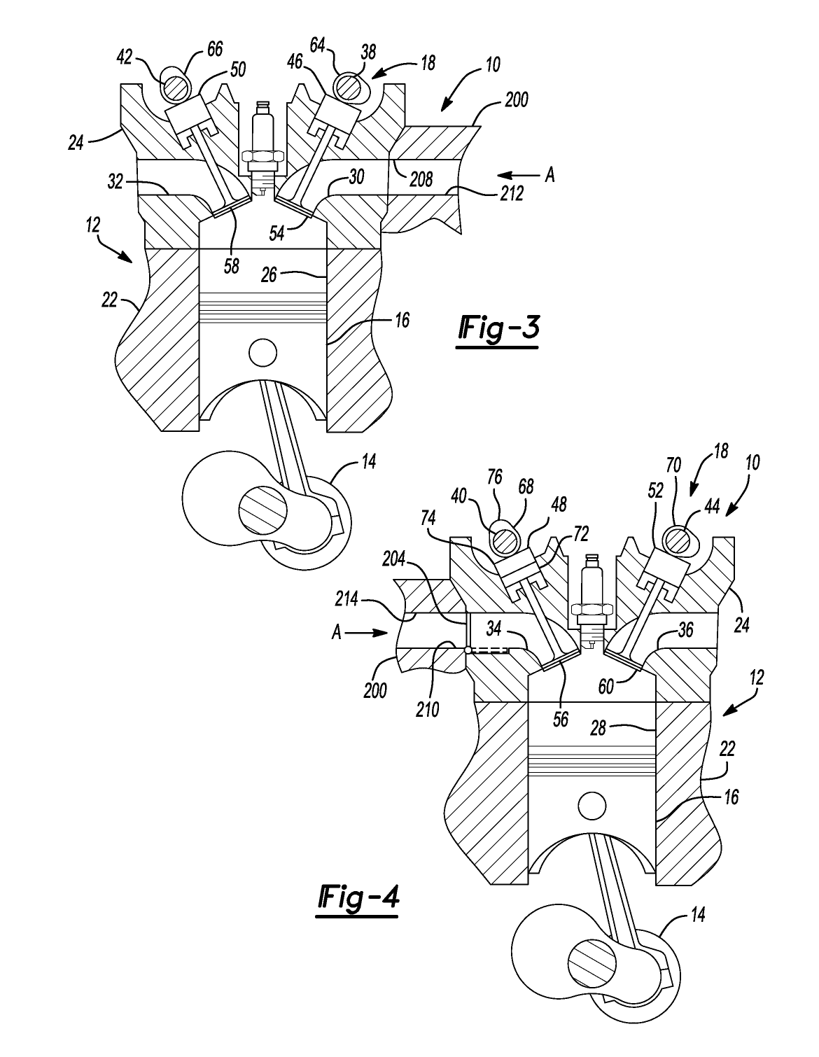

The engine structure 12 may define a first set of intake ports 30 and a first set of exhaust ports 32 in the cylinder head 24 associated with the first bank of cylinder bores 26 and a second set of intake ports 34 and a second set of exhaust ports 36 in the cylinder head 24 associated with the second bank of cylinder bores 28. Referring to FIGS. 3 and 4, the engine assembly 10 will be described relative to a first cylinder bore 26 (included in the first bank of cylinder bores 26) and a second cylinder bore 28 (included in the second bank of cylinder bores 28) for simplicity.

The valvetrain assembly 18 may include first, second, third and fourth camshafts 38, 40, 42, 44, first, second, third and fourth valve lift mechanisms 46, 48, 50, 52, first and second intake valves 54, 56 and first and second exhaust valves 58, 60. With reference to FIG. 3, the first intake valve 54 may be located in the first intake port 30 and the first exhaust valve 58 may be located in the first exhaust port 32. The first valve lift mechanism 46 may be engaged with the first intake valve 54 and a first camshaft lobe 64 defined on the first camshaft 38. The third valve lift mechanism 50 may be engaged with the first exhaust valve 58 and a third camshaft lobe 66 defined on the third camshaft 42.

With reference to FIG. 4, the second intake valve 56 may be located in the second intake port 34 and the second exhaust valve 60 may be located in the second exhaust port 36. The second valve lift mechanism 48 may be engaged with the second intake valve 56 and a second camshaft lobe 68 defined on the second camshaft 40. The fourth valve lift mechanism 52 may be engaged with the second exhaust valve 60 and a fourth camshaft lobe 70 defined on the fourth camshaft 44.

The second valve lift mechanism 48 may form a deactivating valve lift mechanism. More specifically, the second valve lift mechanism 48 (schematically illustrated in FIG. 4) may include a first member 72 engaged with the second intake valve 56 and a second member 74 engaged with the second camshaft lobe 68. The second valve lift mechanism 48 may be operable in first and second modes. The second intake valve 56 may be displaced to an open position by the second valve lift mechanism 48 during the first mode when a peak 76 of the second camshaft lobe 68 engages the second valve lift mechanism 48. The second intake valve 56 may remain in a closed position during the second mode when the peak 76 of the second camshaft lobe 68 engages the second valve lift mechanism 48.

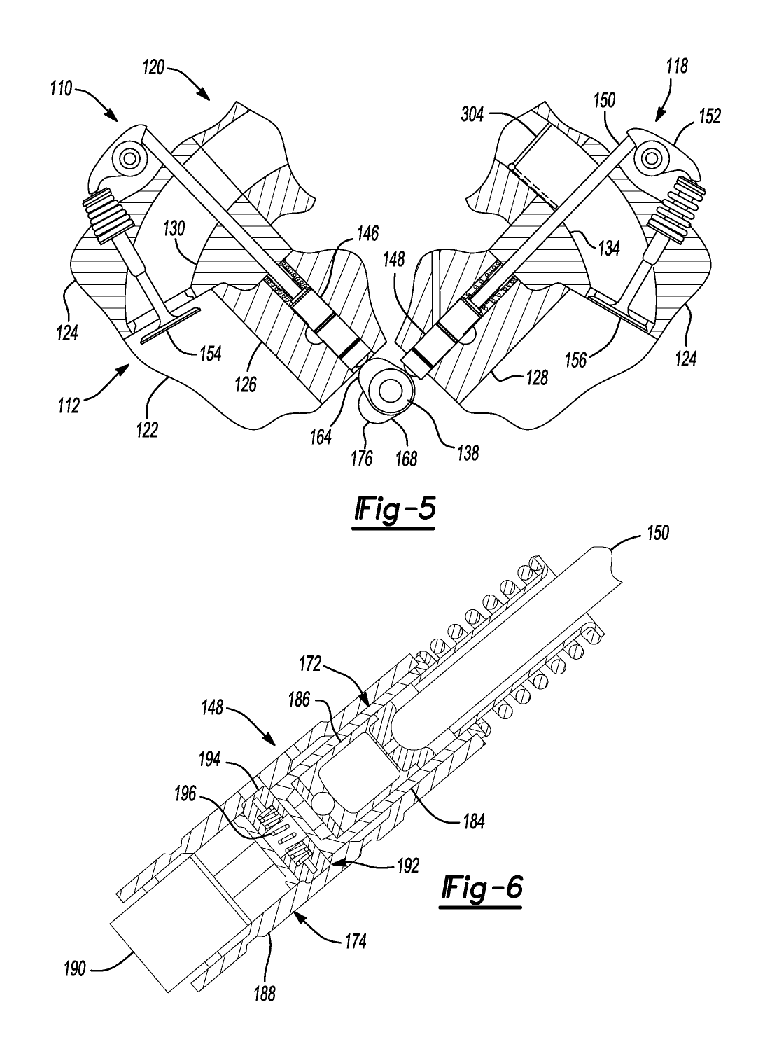

The engine assembly 10 is illustrated as an overhead cam engine. However, as discussed above, the present teachings are not limited to overhead cam engines. FIG. 5 illustrates an exemplary cam-in-block (or pushrod) engine assembly 110. The engine assembly 110 may include an engine structure 112, a crankshaft (not shown), pistons (not shown), a valvetrain assembly 118 and an intake assembly 120. The engine structure 112 may include an engine block 122 and cylinder heads 124. The engine structure 112 may define a first bank of cylinder bores 126 and a second bank of cylinder bores 128 disposed at an angle relative to one another.

The valvetrain assembly 118 may include a camshaft 138, first and second valve lift mechanisms 146, 148, and first and second intake valves 154, 156. The first intake valve 154 may be located in the first intake port 130 and the second intake valve 156 may be located in the second intake port 134. The first valve lift mechanism 146 may be engaged with the first intake valve 154 and a first camshaft lobe 164 defined on the camshaft 138. The second valve lift mechanism 148 may be engaged with the second intake valve 156 and a second camshaft lobe 168 defined on the camshaft 138.

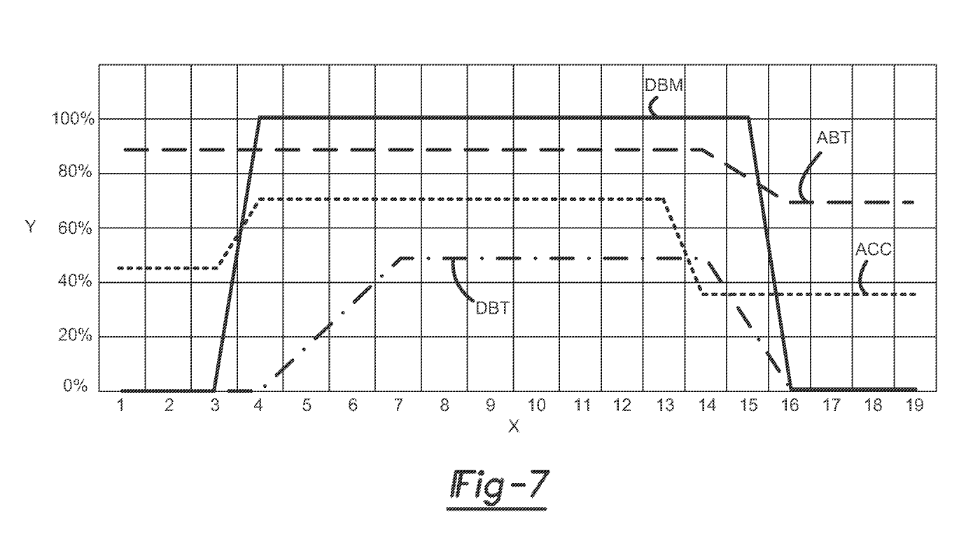

With additional reference to FIG. 6, the second valve lift mechanism 148 may form a deactivating valve lift mechanism. More specifically, the second valve lift mechanism 148 may include a first member 172 engaged with the second intake valve 156 (via a pushrod 150 and rocker arm 152) and a second member 174 engaged with the second camshaft lobe 168. The second valve lift mechanism 148 may be operable in first and second modes. The second intake valve 156 may be displaced to an open position by the second valve lift mechanism 148 during the first mode when a peak 176 of the second camshaft lobe 168 engages the second valve lift mechanism 148. The second intake valve 156 may remain in a closed position during the second mode when the peak 176 of the second camshaft lobe 168 engages the second valve lift mechanism 148.

In the present non-limiting example, the first member 172 of the second valve lift mechanism 148 may include a first housing 184 housing a hydraulic lash adjuster 186 engaged with the pushrod 150. The second member 174 of the second valve lift mechanism 148 may include a second housing 188 and a cam follower 190 coupled to the first housing 184. The second valve lift mechanism 148 may include a locking mechanism 192 that selectively provides operation of the second valve lift mechanism 148 in the first and second modes.

The locking mechanism 192 may include a lock pin 194 and a biasing member 196 fixed to the second member 174. The lock pin 194 may be displaced between first and second positions by a pressurized fluid supply, such as engine oil. In the first position (shown in FIG. 6), the lock pin 194 may extend into the first member 172 and secure the first and second members 172, 174 for axial displacement with one another. In the second position (not shown), the lock pin 194 may extend radially inward relative to the first position to allow axial displacement of the first and second members 172, 174 relative to one another.

The second valve lift mechanism 48 (shown schematically in FIG. 4) may operate in a manner similar to the second valve lift mechanism 148 shown in FIG. 6, having a locking mechanism that selectively fixes the first and second members 72, 74 for displacement with one another. The second valve lift mechanism 48 may take a variety of forms including, but not limited to, a rocker arm and a direct acting lifter.

Referring back to FIGS. 1-4, the first intake ports 30 and the second intake ports 34 may be in communication with an air source (A) via the intake assembly 20. The intake assembly 20 may include an intake manifold 200, a first throttle valve 202 and a second throttle valve 204. The intake manifold 200 may include an inlet 206, a first outlet 208 in communication with the first intake port 30 and a second outlet 210 in communication with the second intake port 34. The engine assembly 10 may define an air flow path from the air source (A) to the second intake port 134 with the first throttle valve 202 located between the air source (A) and the second throttle valve 204. The intake manifold 200 may define parallel flow paths 212, 214 from the inlet 206 to the first and second intake ports 30, 34 with the second throttle valve 204 being located in the flow path from the inlet 206 to the second intake port 34. The second throttle valve 204 may be coupled to the intake manifold 200.

The first throttle valve 202 may be in communication with the air source (A) and the first intake ports 30 and may control air flow from the air source (A) to the inlet 206 and ultimately to the first intake ports 30. The second throttle valve 204 may be in communication with the air source (A) and the second intake ports 34 and may control an air flow from the air source (A) to the second intake ports 34. More specifically, the second throttle valve 204 may control an air flow from the second outlet 210 to the second intake port 34.

The intake assembly 120 shown in FIG. 5 including the second throttle valve 304 may be similar to the intake assembly 20 including the second throttle valve 204. Therefore, for simplicity, the intake assembly 120 will not be described in detail with the understanding that the description of the intake assembly 20 applies equally to intake assembly 120.

The second throttle valve 204, 304 may be a solenoid actuated valve and may be opened and closed during transitions between the first and second modes of the second valve lift mechanism 48, 148. FIG. 7 graphically illustrates operation of the second throttle valve 204, 304 relative to the first and second modes of operation of the second valve lift mechanism 48, 148.

FIG. 7 illustrates a non-limiting example of throttle control relative to deactivation events. Curve (ABT) represents the position of the first throttle valve 202. Curve (DBT) represents the position of the second throttle valve 204, 304. Curve (ACC) represents an accelerator pedal position indicating operator demand. Curve (DBM) represents the operating mode (first mode=100%, second mode=0%) of the second valve lift mechanism 48, 148. The x-axis represents time and the y-axis represents magnitude (opening for first and second throttle valves 202, 204, 304 and operating mode for the second valve lift mechanism 48, 148). The graph in FIG. 7 is for exemplary purposes only and is not intended to limit the disclosure to the specific timing or throttle magnitudes illustrated.

The second throttle valve 204, 304 may be opened during the first mode of operation of the second valve lift mechanism 48, 148. The second throttle valve 204, 304 may be closed during the second mode of operation of the second valve lift mechanism 48, 148. The first throttle valve 202 may remain opened when the second throttle valve 204, 304 is closed.

The first throttle valve 202 may control an intake air flow to the intake manifold 200. Additionally, the first throttle valve 202 may control air flow to the second throttle valve 204, 304. Alternatively, in another non-limiting example, the first throttle valve 202 may control air flow to the first intake port 30 only and the second throttle valve 204 may control air flow to the second intake port 34 independently from the first throttle valve 202. The opening and closing of the second throttle valve 204, 304 may control an intake air flow exiting the intake manifold 200 to the second intake port 34, 134.

As seen in FIG. 7, the second throttle valve 204, 304 may be opened after the second valve lift mechanism 34, 134 is switched from the second mode to the first mode. The second throttle valve 204, 304 may be closed before the second valve lift mechanism 34, 134 is switched from the first mode to the second mode. Providing the overlap between the switching between the first and second modes and opening and closing of the second throttle valve 204, 304 may provide a transition between the first and second modes that is less noticeable to the driver.

By way of non-limiting example, the second throttle valve 204, 304 may be oriented to impart a charge motion into the air flowing into the second cylinder bore 28, 128. More specifically, an intermediate position of the second throttle valve 204, 304 during operation of the second valve lift mechanism 48, 148 in the first mode may introduce swirl or tumble flow characteristics into the air flowing into the second cylinder bore 28, 128.

What is claimed is:

1. An engine assembly comprising:
an engine structure defining a first cylinder bore, a second cylinder bore, a first intake port in communication with an air source and the first cylinder bore, and a second intake port in communication with the air source and the second cylinder bore;
a first intake valve located in the first intake port;
a first valve lift mechanism engaged with the first intake valve;
a second intake valve located in the second intake port;
a second valve lift mechanism engaged with the second intake valve and operable in a first mode and a second mode, the second intake valve being displaced to an open position by the second valve lift mechanism during the first mode and the second intake valve being maintained in a closed position by the second valve lift mechanism during the second mode;
a first throttle valve in communication with the air source and the first intake port and controlling air flow from the air source to the first intake port; and
a second throttle valve in communication with the air source and the second intake port and controlling air flow from the air source to the second intake port.

2. The engine assembly of claim 1, further comprising an intake manifold coupled to the engine structure and defining an inlet, a first outlet in communication with the first intake port and a second outlet in communication with the second intake port, the first throttle valve controlling an air flow from the air source to the inlet and the second throttle valve controlling an air flow from the second outlet to the second intake port.

3. The engine assembly of claim 2, wherein the second throttle valve is coupled to the intake manifold at the second outlet.

4. The engine assembly of claim 3, wherein the second throttle valve extends into the second intake port during the first mode to impart a charge motion into the air flow provided to the second cylinder bore.

5. The engine assembly of claim 1, wherein the intake manifold defines parallel flow paths to the first and second intake ports.

6. The engine assembly of claim 1, wherein a first camshaft lobe is engaged with the first valve lift mechanism and a second camshaft lobe is engaged with the second valve lift mechanism, the second intake valve being displaced to the open position by a peak of the second camshaft lobe during the first mode and the second intake valve remaining in the closed position when the peak of the second camshaft lobe engages the second valve lift mechanism during the second mode.

7. The engine assembly of claim 6, wherein the second valve lift mechanism includes a first member engaged with the second intake valve and a second member engaged with the second camshaft lobe, the first and second members being fixed for displacement with one another during the first mode and being displaceable relative to one another during the second mode.

8. The engine assembly of claim 1, wherein the second throttle valve is closed during the second mode.

9. The engine assembly of claim 1, wherein the engine assembly defines an air flow path from the air source to the second intake port with the first throttle valve being located between the air source and the second throttle valve.

10. The engine assembly of claim 1, wherein the engine structure defines a first bank of cylinder bores including the first cylinder bore and a second bank of cylinder bores including the second cylinder bore and disposed at an angle relative to the first bank of cylinder bores.

11. A method comprising:
controlling an intake air flow to a first intake port of an engine assembly via a first throttle valve;
opening a first intake valve located in the first intake port with a first valve lift mechanism;
operating a second valve lift mechanism in a first mode where the second valve lift mechanism opens a second intake valve in a second intake port of the engine assembly;
opening a second throttle valve in communication with the second intake port during the first mode;
operating the second valve lift mechanism in a second mode where the second valve lift mechanism maintains the second intake valve in a closed position; and
closing the second throttle valve during the second mode.

12. The method of claim 11, wherein the first throttle valve controls an air flow to the second throttle valve.

13. The method of claim 11, further comprising switching the second valve lift mechanism from the second mode to the first mode, the opening the second throttle valve occurring after the switching.

14. The method of claim 11, further comprising switching the second valve lift mechanism from the first mode to the second mode, the closing the second throttle valve occurring before the switching.

15. The method of claim 11, wherein the first throttle valve remains opened when the second throttle valve is closed.

16. The method of claim 11, further comprising controlling an intake air flow into an intake manifold via the first throttle valve, the opening and closing the second throttle valve controlling an intake air flow exiting the intake manifold to the second intake port.

17. The method of claim 11, wherein the first intake valve is opened when the first valve lift mechanism is engaged with a peak of a first camshaft lobe, operating the second valve lift mechanism in the first mode includes opening the second intake valve when the second valve lift mechanism is engaged with a peak of a second camshaft lobe and operating the second valve lift mechanism in the second mode includes the second intake valve remaining in the closed position when the peak of the second camshaft lobe engages the second valve lift mechanism.

18. A method comprising:
controlling an intake air flow to a first intake port of an engine assembly via a first throttle valve;
opening a first intake valve located in the first intake port with a first valve lift mechanism when the first valve lift mechanism is engaged with a peak of a first camshaft lobe;
switching a second valve lift mechanism between first and second modes, the first mode including the second valve lift mechanism opening a second intake valve in a second intake port of the engine assembly when engaged with a peak of a second camshaft lobe and the second mode including the second intake valve remaining closed when the second valve lift mechanism is engaged with the peak of the second camshaft lobe;
opening a second throttle valve in communication with the second intake port after the second valve lift mechanism is switched from the second mode to the first mode; and
closing the second throttle valve before the second valve lift mechanism is switched from the first mode to the second mode.

19. The method of claim 18, wherein the first throttle valve remains opened when the second throttle valve is closed.

20. The method of claim 18, further comprising controlling an intake air flow into an intake manifold via the first throttle valve, the intake manifold defining parallel flow paths from the first throttle valve to the first and second intake ports and the opening and closing the second throttle valve controlling an intake air flow exiting the intake manifold to the second intake port.
